(19) United States
(12) Patent Application Publication
(10) Pub. No.: US 2018/0238744 A1
(43) Pub. Date: Aug. 23, 2018

(54) Temperature Measuring Device with Reference Temperature Determination

(71) Applicant: Endress + Hauser Wetzer GmbH + Co. KG, Nesselwang (DE)

(72) Inventors: Thomas Harle, Oy-Mittelberg (DE); Bjorn Walser, Oberstaufen (DE)

(21) Appl. No.: 15/750,548

(22) PCT Filed: Jul. 26, 2016
(86) PCT No.: PCT/EP2016/067741

§ 371 Date: Feb. 6, 2018

(30) Foreign Application Priority Data
Aug. 20, 2015 (DE) 10 2015 113 842.5

(51) Int. Cl. G01K 7/02; G01K 7/13

(52) U.S. Cl. CPC G01K 7/023; G01K 7/13

(57) ABSTRACT

A measuring apparatus for determining a measurement temperature at a measuring point by means of a first thermocouple. The measuring apparatus includes a first connection terminal and a second connection terminal for connecting the first thermocouple, a first connecting line and a second connecting line, which connect the first and second connection terminals with an evaluating electronics, an auxiliary temperature sensor, which is designed to register an auxiliary temperature, and the evaluating electronics, which is designed to determine the measurement temperature at the measuring point. An additional connecting line, which is composed of a material other than that of the second connecting line forms together with the second connecting line a second thermocouple, which is likewise connected to the evaluating electronics. The evaluating electronics is designed to determine the measurement temperature at the measuring point based on a first measurement voltage delivered by the first thermocouple, the second measurement voltage delivered by the second thermocouple and the auxiliary temperature registered by the auxiliary temperature sensor.

The invention relates to a measuring apparatus for determining a measurement temperature at a measuring point by means of a thermocouple as well as to a temperature measuring device for determining a measurement temperature at a measuring point. Furthermore, the invention relates to a method for determining a measurement temperature at a measuring point.

In automation technology, field devices are often applied, which serve for registering and/or influencing process variables. Examples of such field devices are fill level measuring devices, mass flow measuring devices, pressure- and temperature measuring devices, etc., which as sensors register the corresponding process variables, fill level, flow, pressure, and temperature.

In the case of industrial temperature measurement, thermocouples are applied in many fields of use. A thermocouple delivers a measurement voltage, based on which the temperature difference occurring along the thermocouple can be determined. In order with the assistance of this temperature difference to be able to determine the measurement temperature at the tip of the thermocouple, the reference temperature at the connections of the thermocouple must be known as exactly as possible. The more exactly the reference temperature is known, the more exactly the measurement temperature can be determined.

It is, consequently, an object of the invention to provide a temperature measuring device as well as a method for temperature measurement, which enables with little extra effort a more exact determining of the reference temperature for a thermocouple.

This object is achieved by the features set forth in claims 1, 7 and 18.

Advantageous further developments of the invention are set forth in the dependent claims.

A measuring apparatus for determining a measurement temperature at a measuring point by means of a first thermocouple corresponding to the forms of embodiment of the invention includes a first connection terminal and a second connection terminal for connecting the first thermocouple, a first connecting line and a second connecting line, which connect the first and second connection terminals with an evaluating electronics, an auxiliary temperature sensor, which is arranged removed from the connection terminals and is designed to register an auxiliary temperature at the site of the auxiliary temperature sensor, and an evaluating electronics, which is designed to determine the measurement temperature at the measuring point. Connected at the second connection terminal with the second connecting line is an additional connecting line, which is composed of a material other than that of the second connecting line. The additional connecting line forms together with the second connecting line a second thermocouple, which is likewise connected to the evaluating electronics. The second thermocouple delivers a second measurement voltage, which depends on the second temperature difference between the temperature of the second connection terminal and the auxiliary temperature at the site of the auxiliary temperature sensor. The evaluating electronics is designed, based on a first measurement voltage delivered by the first thermocouple, the second measurement voltage delivered by the second thermocouple and the auxiliary temperature registered by the auxiliary temperature sensor, to determine the measurement temperature at the measuring point.

For the accuracy of a temperature measurement by means of a thermocouple, it is important to determine the reference temperature at the connection locations, or connection terminals, of the thermocouple with best possible accuracy. For this, in many cases, a separate auxiliary temperature sensor is provided.

However, the auxiliary temperature sensor is, as a rule, arranged somewhat removed from the connection terminals, so that the auxiliary temperature ascertained by the auxiliary temperature sensor does not exactly correspond to the temperature of the connection terminals. There is thus a second temperature difference between the auxiliary and temperature measured by the auxiliary temperature sensor and the temperature of the connection terminals. In order to register this temperature difference and to be able to determine the reference temperature reigning at the connection terminals with high accuracy, the second thermocouple is applied. This second thermocouple is formed by connecting to the second connecting line of the second connection terminal an additional connecting line, which is composed of a material other than that of the second connecting line. This second thermocouple registers the second temperature difference between the auxiliary temperature registered by the auxiliary temperature sensor and the temperature at the connection terminals. In this way, the reference temperature reigning at the connection terminals can be determined with high accuracy. Based on the more exactly than previously known reference temperature, then the measurement temperature actually of interest can be determined with high accuracy with the assistance of the first thermocouple. The second thermocouple permits determining the temperature at the connection terminals with very little extra constructional effort. It is only required that an additional connecting line be connected with the second connecting line.

In the following, the invention will now be explained in greater detail based on examples of embodiments illustrated in the drawing. The figures of the drawing show as follows:

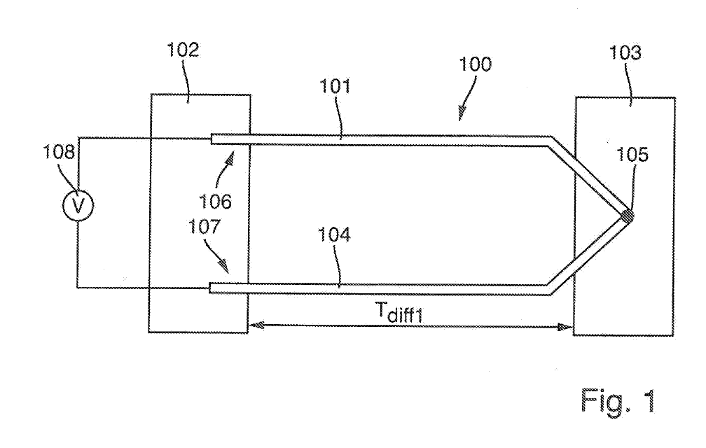

FIG. 1 the basics of a temperature measurement by means of a thermocouple;

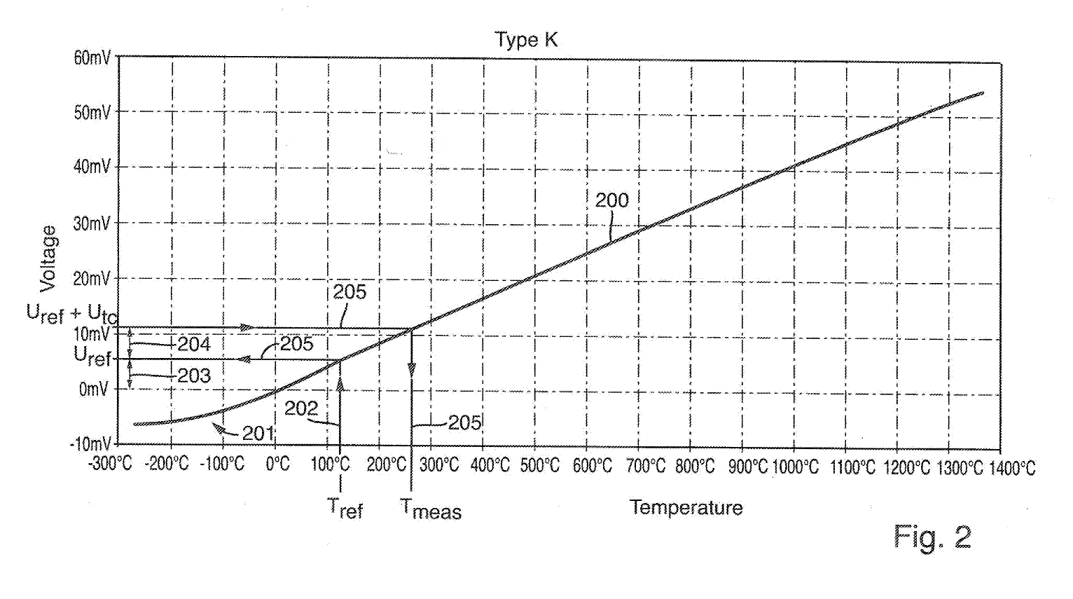

FIG. 2 a transfer characteristic line for a thermocouple of type K, wherein plotted is the voltage measured across the ends of the thermocouple as a function of the temperature difference between measuring point and reference junction;

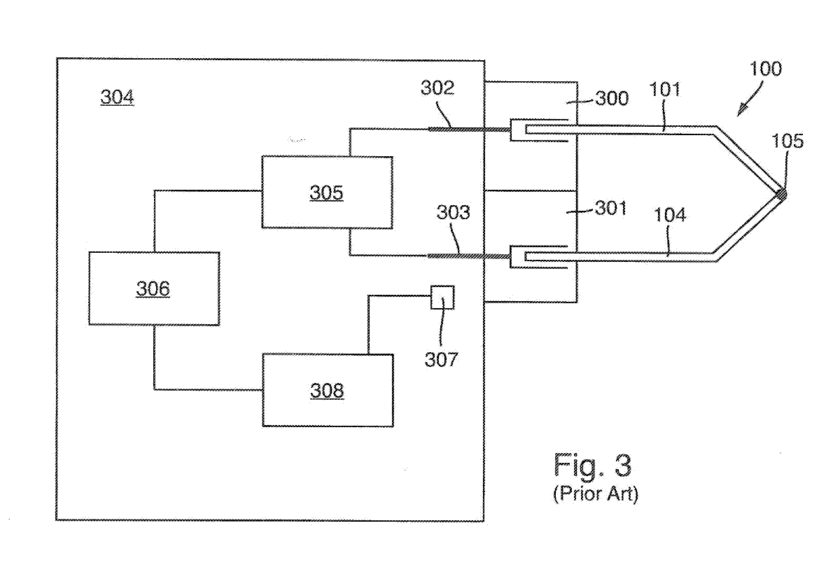

FIG. 3 a temperature measuring device of the state of the art;

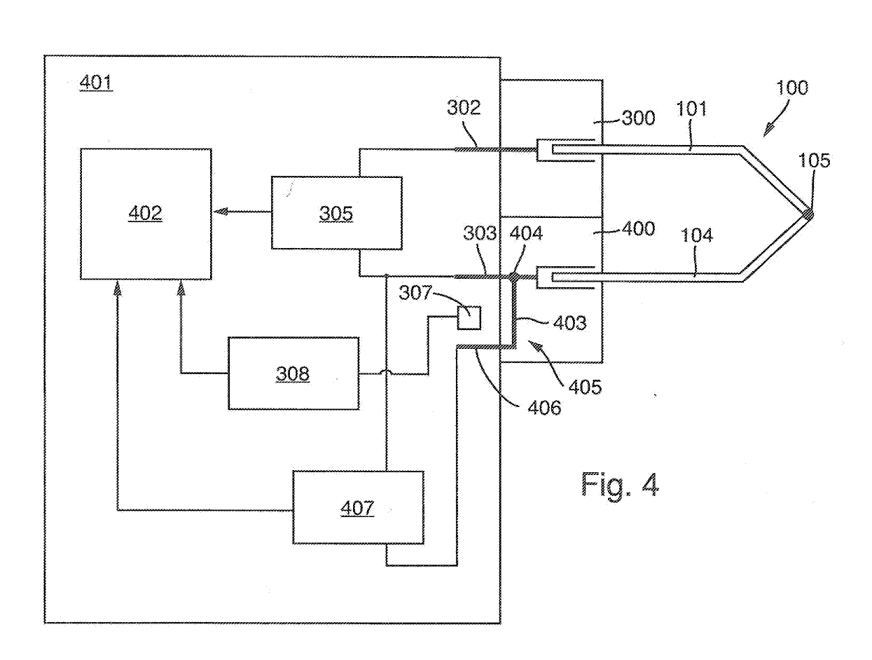

FIG. 4 a temperature measuring device with a second thermocouple, which enables an exact determining of the reference temperature for the first thermocouple; and

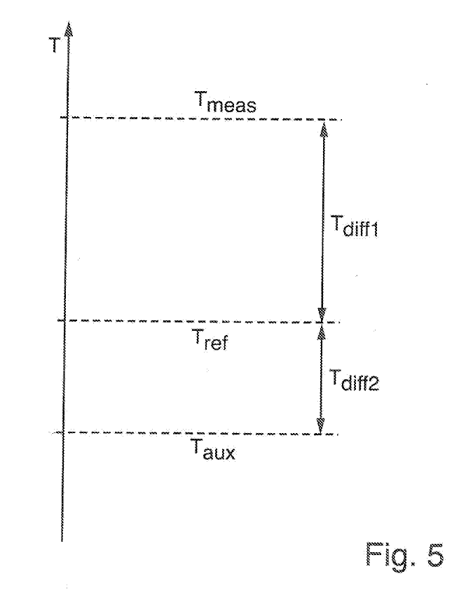

FIG. 5 an illustration of the different temperatures in the temperature measuring device shown in FIG. 4.

In the field of industrial measurements technology, thermocouples are frequently applied for temperature measurement. FIG. 1 shows schematically the measuring principle of a temperature measurement by means of a thermocouple, A thermocouple 100 is composed of a first conductor 101, which is composed of a first metal, e.g. a first alloy. This first conductor 101 extends from a reference junction 102 to a measuring point 103, whose temperature Tₘₑₐₛ is to be determined. Extending in parallel with the first conductor 101 from the reference junction 102 to the measuring point 103 is a second conductor 104.

The second conductor 104 is composed of a second metal, e.g. a second alloy, which differs from the first metal or the first alloy. For the thermocouple 100 to function, it is essential that the two conductors 101, 104 be of different materials. The two conductors 101, 104 are electrically connected with one another at a contact location 105. This can occur, for example, by soldering, brazing or welding the ends of the two conductors 101, 104. The contact location 105 serves as measuring probe and assumes the temperature Tₘₑₐₛ of the measuring point 103. This temperature Tₘₑₐₛ is to be determined by means of the thermocouple 100. The ends 106, 107 of the two conductors 101, 104 removed from the contact location 105 have the temperature T_{ref}, which reigns at the reference junction 102. Insofar, the ends 106, 107 at the reference junction 102 have the temperature T_{ref}, while, in contrast, the contact location 105 has the temperature Tₘₑₐₛ. The temperature difference T_{diff1}=(Tₘₑₐₛ−T_{ref}) between the reference junction 102 and the measuring point 103 is indicated in FIG. 1.

The functioning of thermocouple 100 rests on the Seebeck effect. Referred to as the Seebeck effect is the occurrence of a thermovoltage between two locations of a conductor at different temperatures. As a result of the Seebeck effect, there forms along the first conductor 101, which is composed of the first metal, e.g. the first alloy A, a Seebeck voltage U_{A}, which in linear approximation can be expressed as follows:

U_{A}=S_{A}·(Tₘₑₐₛ−T_{ref})

wherein S_{A} refers to the Seebeck coefficient, which is usually given in microvolt per Kelvin. The Seebeck coefficient S_{A} converts the temperature difference existing along a conductor into the Seebeck voltage U_{A} occurring across the ends of the conductor.

For the second conductor 104, which is composed of the second metal, e.g. the second alloy B, one obtains in linear approximation a Seebeck voltage U_{B}:

U_{B}=S_{B}·(Tₘₑₐₛ−T_{ref})

wherein S_{B} refers to the Seebeck coefficient of the second metal, e.g. the second alloy B. The Seebeck voltage U_{B} occurring across the second conductor 104 is oppositely poled to the Seebeck voltage U_{A} arising across the first conductor 101. Between the ends 106, 107 of the two conductors 101, 104 there lies, consequently, a voltage U_{tc} (“tc” stands for “thermocouple”). This voltage U_{tc} corresponds to the difference between the thermovoltages U_{A} and U_{B} of the participating metals, e.g. alloys:

U_{tc}=U_{B}−U_{A}=(S_{B}−S_{A})·(Tₘₑₐₛ−T_{ref})

The voltage U_{tc} tappable at the reference junction 102 across the ends 106, 107 depends thus, on the one hand, on the difference between the Seebeck coefficients S_{A} and S_{B} and, on the other hand, on the temperature difference (Tₘₑₐₛ−T_{ref}). However, also the Seebeck coefficients S_{A} and S_{B} have a certain temperature dependence. To take the temperature dependence of the Seebeck coefficients S_{A}(T) and S_{B}(T) into consideration, the voltage Utc on the conductors 101, 104 can be determined by means of the following integral:

U_{tc}=∫_{T1}^{T2}(S_{B}(T)−S_{A}(T))dT

The relationship between temperature difference and thermovoltage is thus not completely linear. More or less strongly marked non-linearities are present as a function of the material pairing.

For evaluation, the thermovoltage U_{tc} between the ends 106, 107 of the two conductors 101 and 104 is measured. Thus, in FIG. 1, a voltage measuring device 108 is connected between the two ends 106 and 107 of the thermocouple 100. The measured ther and in movoltage U_{tc} enables an inference of the temperature difference T_{diff1}=(Tₘₑₐₛ−T_{ref}) between the measuring point 103 and the reference junction 102. In order, based on this temperature difference, to be able to determine the desired temperature Tₘₑₐₛ of the measuring point 103, supplementally also the temperature T_{ref} of the reference junction 102 must be known. This temperature T_{ref} of the reference junction 102 is frequently determined by means of an additional temperature sensor, for example, by means of a resistance temperature sensor or RTD (Resistance Temperature Device).

The relationship between the temperature difference T_{diff1}=(Tₘₑₐₛ−T_{ref}) arising along the thermocouple 100 and the associated thermovoltage U_{tc} across the two ends 106, 107 is described with the assistance of a so-called transfer characteristic line. FIG. 2 shows an example of such a transfer line 200 for a thermocouple of type K. In the case of a thermocouple of type K, the material pairing nickel-chromium/nickel (NiCr—Ni) is used. The first conductor 101 of the thermocouple 100 is composed thus of nickel-chromium, while the second conductor 104 is composed of nickel. Such thermocouples of type K are applicable in a temperature range from about 0° C. to about 1100° C. The graph shown in FIG. 2, plotted along the horizontal axis is the temperature difference T_{diff1} applied to the thermocouple, and plotted along the vertical axis is the thermovoltage U_{tc} tappable across the ends of the thermocouple.

Based on FIG. 2, it can be seen that there is essentially a linear relationship between the temperature difference T_{diff1} and the associated thermovoltage U_{tc}, wherein, for example, in region 201 deviations from the linear relationship can be seen. In order within a measuring device to be able to evaluate the thermovoltage U_{tc} arising on a thermocouple as exactly as possible, the transfer characteristic line 200 is recreated as exactly as possible by means of a polynomial of 6th, 7th or even higher degree, in order, in this way, to enable based on the thermovoltage U_{tc} an as exact as possible determining of the temperature difference T_{diff1} between the measurement temperature Tₘₑₐₛ at the measuring point 103 and the temperature T_{ref} at the reference junction 102.

In order to calculate therefrom the temperature Tₘₑₐₛ of the measuring point, supplementally the temperature T_{ref} of the reference junction must be known. This reference temperature T_{ref} can be measured, for example, by means of an additional temperature sensor mounted at the reference junction 102, for example, with the assistance of a resistance temperature sensor (RTD, Resistance Temperature Device). The so ascertained reference temperature T_{ref} can then be converted with the assistance of the transfer characteristic line 200 shown in FIG. 2 into a corresponding reference voltage U_{ref}. This is illustrated in FIG. 2 by the arrows 202. The so obtained reference voltage U_{ref} corresponds to the reference temperature T_{ref} reigning at the reference junction 102. The reference voltage U_{ref} is indicated in FIG. 2 by the double arrow 203.

Next there is added to this reference voltage U_{ref} the thermovoltage U_{tc} tappable across the ends of the thermocouple. Thermovoltage U_{tc} is indicated by the double arrow 204. As a result, one obtains the summed voltage (U_{ref}+U_{tc}), which is next with the assistance of the transfer characteristic line 200 translated back into an associated temperature. This is illustrated in FIG. 2 by the arrows 205. Since the reference voltage U_{tc} corresponds to the reference temperature T_{ref} and the thermovoltage U_{tc} to the difference temperature T_{diff1}=(Tₘₑₐₛ−T_{ref}), the summed voltage (U_{ref}+U_{tc}) corresponds to the measurement temperature Tₘₑₐₛ at the measuring point 103. As a result of the conversion illustrated by the arrows 205, one obtains, consequently, the desired measurement temperature Tₘₑₐₛ. For the procedure shown in FIG. 2, typically, the reference temperature T_{ref} is first converted into a corresponding reference voltage U_{ref} and the temperature evaluation is then performed in terms of a voltage addition.

Besides the already described thermocouple of type K, there exist a large number of additional, standardized thermocouples, which are usually referred to with capital letters. From these types of thermocouples, the user can select the most suitable thermocouple for the particular application. The most common types of thermocouples, with their material pairings and associated temperature ranges, are as follows:
type K, nickel-chromium/nickel (NiCr—Ni), temperature range 0-1100° C.;
type J, iron/copper-nickel (Fe—CuNi), temperature range 0-750° C.;
type N, nickel-chromium-silicon/nickel-silicon (NiCrSi—NiSi), temperature range 0-1100° C.;
type R, platinum 13 rhenium/platinum (Pt13Rh—Pt), temperature range 0-1600° C.;
type S, platinum 10 rhenium/platinum (Pt10Rh—Pt), temperature range 0-1600° C.;
type B, platinum 30 rhenium/platinum 6 rhenium (Pt30Rh—Pt6Rh), temperature range +200° C. to +1700° C.;
type T, copper/copper-nickel (Cu—CuNi), temperature range −185 to +300° C.;
type E, nickel-chromium/copper-nickel (NiCr—CuNi), temperature range 0-800° C.;
etc.

This listing is not exclusive, there are yet a large number of other thermocouples.

In the case of temperature measuring devices, the thermocouple is often connected with the evaluating electronics via a separable connection, for example, by means of connection terminals. In this way, different thermocouples can be connected to an evaluating electronics as a function of the application.

FIG. 3 shows a block diagram of such a temperature measuring device corresponding to the state of the art. The temperature measuring device includes a first connection terminal 300 as well as a second connection terminal 301, to which a thermocouple 100 can be connected. The first conductor 101 of the thermocouple 100 can be clamped tightly to the first connection terminal 300, and the second conductor 104 can be clamped tightly to the second connection terminal 301. The first connection terminal 300 is connected with the evaluating electronics 304 via a first connection pin 302 and the second connection terminal 301 is connected with the evaluating electronics 304 via a second connection pin 303. The evaluating electronics 304 includes a first measuring unit 305, which is designed to evaluate the thermovoltage U_{tc} tappable across the two connection pins 302, 303. The ascertained thermovoltage U_{tc} is then fed to the processing unit 306.

For determining the measurement temperature Tₘₑₐₛ at the contact location 105, supplementally to the thermovoltage U_{tc} between the connection pins 302, 303, also the reference temperature T_{ref} at the reference junction is required. The reference junction here is the interior of the two connection terminals 300, 301, for that is where the transitions between the conductors 101, 104 of the thermocouple 100 and the associated connection pins 302, 303 of the measuring device occur. For correctly determining the measurement temperature Tₘₑₐₛ, the reference temperature T_{ref} would thus be determined within the two connection terminals 300, 301. However, the insertion of an additional temperature sensor within the connection terminals 300, 301 would be complex and, thus, also expensive.

In the case of the temperature measuring device shown in FIG. 3, an auxiliary temperature sensor 307 is placed removed from the connection terminals 300, 301, preferably at a position near to the connection terminals 300, 301. The auxiliary temperature sensor 307 can be placed, for example, within the housing of the evaluating electronics 304 in the vicinity of the connection terminals 300, 301. For example, the auxiliary temperature sensor 307 can be placed on a circuit board of the evaluating electronics in the vicinity of the connection terminals 300, 301. Associated with the auxiliary temperature sensor 307 is a second measuring unit 308, which converts the temperature dependent variable (for example, the resistance) provided by the auxiliary temperature sensor 307 into an associated auxiliary temperature Tₐᵤₓ. The second measuring unit 308 provides this auxiliary temperature Tₐᵤₓ to the processing unit 306.

This procedure has, however, disadvantages, because the auxiliary temperature sensor 307 ascertains an auxiliary temperature Tₐᵤₓ, which differs more or less strongly from the actual reference temperature T_{ref} within the connection terminals 300, 301. This temperature difference between the measured auxiliary temperature Tₐᵤₓ and the actual reference temperature T_{ref} at the location of the connection terminals 300, 301 enters as an error into the measuring of the measurement temperature Tₘₑₐₛ.

The temperature difference between the auxiliary temperature Tₐᵤₓ at the site of the auxiliary temperature sensor 307 and the actual reference temperature T_{ref} within the connection terminals 300, 301 is influenced by different factors. A role is played, for example, by the self-warming of the evaluating electronics 304 during the ongoing operation. Moreover, the temperature measured by the auxiliary temperature sensor 307 depends also on the heat input by adjoining devices. As a result of heat emission from neighboring devices, an additional warming of the auxiliary temperature sensor 307 can occur. Other influencing factors to be taken into consideration are the position of the connection terminals 300, 301 as well as the thermal coupling between the connection terminals 300, 301 and the auxiliary temperature sensor 307. On the whole, the temperature difference T_{diff2} between the auxiliary temperature Tₐᵤₓ measured by the auxiliary temperature sensor 307 and the reference temperature T_{ref} reigning at the site of the connection terminals 300, 301 can amount to several degrees Celsius and, thus, can produce a considerable measurement error. As a result of the inexact determining of the reference temperature T_{ref}, then also the measurement temperature Tₘₑₐₛ is burdened with a measurement inaccuracy of several degrees Celsius. This is unacceptable for many applications.

When one would rather not tolerate the measurement error caused by the inexact determining of the reference temperature T_{ref}, the auxiliary temperature sensor 307 could be incorporated into the connection terminals 300, 301. This would mean, however, that standard connection terminals could no longer be used, but, instead, expensive, custom-made products would be required. A further approach for lessening the measurement error caused by the auxiliary temperature sensor 307 would be to determine the size of this measurement error by calculation based on the operating parameters and then to compensate such during the calculations. Here to be noted, however, is that the evaluating electronics 304 shown in FIG. 3 is used in a large number of highly different applications. Temperature measuring devices are obtainable in a large number of different housing variants, for example, as a head transmitter, in a DIN rail housing or in a round metal housing, also referred to as a “field housing”. Depending on embodiment and housing type, for example, also the thermal coupling to neighboring devices differs. A calculational compensation of the temperature difference between Tₐᵤₓ and T_{ref} is, consequently, not really practical.

For ascertaining the temperature difference between the auxiliary temperature Tₐᵤₓ registered by the auxiliary temperature sensor 307 and the actual reference temperature T_{ref}, it is proposed according to the invention to register this second temperature difference T_{diff2}=(T_{ref}−Tₐᵤₓ) with the assistance of an additional, second thermocouple, which can be integrated into one of the connection terminals 300, 301 without much extra effort. A corresponding circuit is shown in FIG. 4. In FIG. 4, features, which are the same or similar to features already shown in FIG. 3, are provided with the same reference characters as in FIG. 3, so that in the following primarily differences will be explored and otherwise reference is taken to the description of FIG. 3.

The temperature measuring device shown in FIG. 4 includes two connection terminals 300, 400, to which a thermocouple 100 can be connected. For this, the first conductor 101 of the thermocouple 100 is clamped tightly in the first connection terminal 300, and the second conductor 104 is clamped tightly in the second connection terminal 400. Via the first connection pin 302 and the second connection pin 303, the two connection terminals 300, 400 are electrically connected with an evaluating electronics 401. Between the two connection pins 302 and 303 lies the thermovoltage U_{tc} delivered by the thermocouple 100. The thermovoltage U_{tc} is determined by the temperature difference between the measurement temperature Tₘₑₐₛ at the contact location 105 and the reference temperature T_{ref} within the connection terminals 300, 400. This thermovoltage U_{tc} present between the connection pins 302, 303 is evaluated by the first measuring unit 305 and the result is fed to the processing unit 402.

Moreover, the evaluating electronics includes the auxiliary temperature sensor 307, which is designed to determine an auxiliary temperature Tₐᵤₓ. The auxiliary temperature sensor 307 is arranged removed from the two connection terminals 300, 400, preferably at a position near to the connection terminals 300, 400. The auxiliary temperature sensor 307 can be placed, for example, within the housing of the evaluating electronics 401 in the vicinity of the connection terminals 300, 400. For example, the auxiliary temperature sensor 307 can be placed on a circuit board of the evaluating electronics in the vicinity of the connection terminals 300, 400. The auxiliary temperature sensor 307 can be, for example, a resistance temperature sensor (RTD, Resistance Temperature Device). Associated with the auxiliary temperature sensor 307 is the second measuring unit 308, which converts the temperature dependent variable (for example, the resistance) provided by the auxiliary temperature sensor 307 into the associated auxiliary temperature Tₐᵤₓ and provides this auxiliary temperature to the processing unit 402.

Depending on position of the auxiliary temperature sensor 307, the measured auxiliary temperature Tₐᵤₓ differs more or less strongly from the reference temperature T_{ref} reigning within the connection terminals 300, 400, which reference temperature T_{ref} one would actually use for determining the measurement temperature Tₘₑₐₛ, which, however, is metrologically difficulty accessible, because one would have to the register temperature in the interior of the connection terminals 300, 400.

For determining the temperature difference T_{diff2}=(T_{ref}−Tₐᵤₓ) between the temperature at the site of the auxiliary temperature sensor 307 and the temperature in the interior of the connection terminal in the case of the solution shown in FIG. 4, there is placed on the second connection pin 303 in the interior of the second connection terminal 400 an additional connecting line 403. Additional connecting line 403 is electrically connected with the second connection pin 303 at a junction 404. The material of this additional connecting line 403 differs from the material of the second connection pin 303, so that the second connection pin 303 together with the additional connecting line 403 acts as a second thermocouple 405. The two materials are electrically connected with one another at the junction 404. For example, the additional connecting line 403 can be soldered or welded to the second connection pin 303.

The additional connecting line 403 is preferably led out from the second connection terminal 400 in the form of a third connection pin 406. In such case, the additional connecting line 403 and the third connection pin 406 are of the same material. Since the material of the second connection pin 303 differs from the material of the additional connecting line 403 and the third connection pin 406, the second connection pin 303 forms together with the additional connecting line 403 and, in given cases, the third connection pin 406 the second thermocouple 405.

This second thermocouple 405 is designed to measure a temperature difference T_{diff2} between the temperature at the site of the auxiliary temperature sensor 307 and the temperature in the interior of the second connection terminal 400. When the temperature Tₐᵤₓ at the site of the auxiliary temperature sensor 307 differs from the reference temperature T_{ref} in the interior of the second connection terminal 400, then there arises between the connection pins 303 and 406 a thermovoltage U_{tc2}, which depends on this second temperature difference T_{diff2}=(T_{ref}−Tₐᵤₓ). With the help of this second thermocouple 405, thus the second temperature difference T_{diff2} between the temperature in the interior of the second connection terminal 400 and the temperature at the site of the auxiliary temperature sensor 307 can be measured exactly. In this regard, the two connection pins 303, 406 are connected with a third measuring unit 407, which is designed to evaluate the thermovoltage U_{tc2} tappable between the two connection pins 303, 406 and to supply the result to the processing unit 402. In such case, it is to be heeded that the ends of the two connection pins 303, 406 are arranged in the immediate vicinity of the auxiliary temperature sensor 307, in order that the auxiliary temperature Tₐᵤₓ measured by the auxiliary temperature sensor 307 corresponds exactly to the temperature at the ends of the two connection pins 303, 406 and the auxiliary temperature sensor 307, thus, registers the reference temperature for the second thermocouple 405.

Starting from the auxiliary temperature Tₐᵤₓ registered by the auxiliary temperature sensor 307 and the thermovoltage U_{tc2} across the ends of the second thermocouple 405, the temperature in the interior of the second connection terminal 400 can be determined by means of the transfer characteristic line of the second thermocouple 405. In this way, one obtains the actual reference temperature T_{ref} in the interior of the second connection terminal 400.

In a second step, then, based on the so ascertained reference temperature T_{ref} and the thermovoltage U_{tc1} across the ends of the first thermocouple 100, the temperature Tₘₑₐₛ at the measuring point is determined by means of the transfer characteristic line of the first thermocouple 100.

In summary, thus by means of a two-stage evaluation, one can determine the measurement temperature Tₘₑₐₛ at the contact location 105 from the auxiliary temperature Tₐᵤₓ, the second of thermovoltage U_{tc2} delivered by the second thermocouple 405 and the first thermovoltage U_{tc1} delivered by the first thermocouple 100.

The advantage of the circuit shown in FIG. 4 is that the second thermocouple 405 can be implemented without mentionable additional structural effort. It is only required to connect to the already present, second connection pin 303 an additional connecting line 403, which is composed of a material other than that of the second connection pin 303. This additional connecting line 403 is then led out of the second connection terminal 400 by means of a third connection pin 406. This third connection pin 406 can be embodied as one piece with the additional connecting line 403, which third connection pin 406 can, however, also be embodied as a separate connection pin, which is electrically connected with the additional connecting line 403. The so formed second thermocouple 405 is suitable for exactly determining the required temperature difference between the reference temperature T_{ref} and the auxiliary temperature Tₐᵤₓ measured removed from the second connection terminal 400.

Because of its simplicity, the second thermocouple 405 shown in FIG. 4 can be integrated without problem into different types of connection terminals. Temperature transmitters are, as a rule, obtainable in a large number of different housing variants. For example, a temperature transmitter can be implemented as a so-called head transmitter and be installed in a puck shaped housing of about 4 cm diameter. In the case of a head transmitter, the connection terminals are externally accessible. For example, the connection terminals can be embodied integrated into the housing. Moreover, temperature transmitters are offered, which are installed in a DIN rail housing, which is designed for mounting on a top hat rail. In the case of such DIN rail housings, the connection terminals for a thermocouple are embodied in the form of a pin connector socket. Also a supplemental second thermocouple 405 can be introduced into such a pin connector socket. Another housing variant for thermotransmitters is a round field housing with a housing diameter of about 10 cm, which frequently is embodied as a two-part, explosion protected housing. In the case of this housing type, a separate connector space is provided, in which the connection terminals are arranged. In the case of all the mentioned housing variants, the connection terminals can be so modified that the required second thermocouple 405 is embodied in the connection terminal.

The materials of the first connection pin 302 and of the second connection pin 303, on the one hand, and the additional connecting line 403 and the third connection pin 406, on the other hand, must be so selected that a thermocouple suitable for measurements at operating temperature results. Moreover, the materials must be so selected that the second connection terminal 400 can be manufactured without problems. The connection pins 302, 303 can be, for example, of copper. In this case, a second material is required, which forms a suitable thermocouple with copper, wherein here, for example, constantan is a possibility. One could thus, for example, manufacture the first connection pin 302 and the second connection pin 303 of copper and the additional connecting line 403 and the third connection pin 406 of constantan. In this way, a thermocouple of type T (copper/copper-nickel) is formed. This is, however, only one example. The second thermocouple 405 could e.g. also be a thermocouple of type J (iron/copper-nickel), of type K (nickel-chromium/nickel) or of type E (nickel-chromium/copper-nickel). Ultimately, used for the second thermocouple 405 can be any material pairing, with which temperature differences at operating temperature can be sensibly measured.

For fulfillment of the different measuring tasks, different thermocouples 100 with different material pairings can be connected at the connection terminals 300, 400 of the temperature measuring device shown in FIG. 4. As a rule, it is, consequently, to be assumed therefrom that the material pairing of the first thermocouple 100 is not the same as the material pairing of the second thermocouple 405. Therefore, there is required for translation of the thermovoltage U_{tc} on the first thermocouple 100 into a corresponding first temperature difference T_{diff1} a first transfer characteristic line, which fits the material pairing of the first thermocouple 100. In contrast, for conversion of the thermovoltage U_{tc2} on the second thermocouple 405, a transfer characteristic line is required, which fits the material pairing of the second thermocouple 405. For each of the two thermocouples 100, 405, there is, thus, as a rule, in each case, a separate transfer characteristic line required. In such case, always the same transfer characteristic line is used for the second thermocouple 405.

The different temperatures, which occur in the case of the temperature measuring device shown in FIG. 4, are illustrated in FIG. 5. FIG. 5 shows the auxiliary temperature Tₐᵤₓ, which is ascertained by the auxiliary temperature sensor 307 at the site of the auxiliary temperature sensor 307 removed from the connection terminals 300, 400. Moreover, the reference temperature T_{ref} is shown, which reigns within the connection terminals 300, 400 and which serves as reference temperature for the first thermocouple 100. Also shown is the measurement temperature Tₘₑₐₛ at the tip of the first thermocouple 100, such being the temperature to be determined by means of the temperature measurement.

FIG. 5 shows the first temperature difference T_{diff1}=Tₘₑₐₛ−T_{ref}, which is registered with the assistance of the first thermocouple 100. Moreover, the second temperature difference T_{diff2}=T_{ref} Tₐᵤₓ is shown, which is registered by means of the second thermocouple 405.

The determining of the measurement temperature Tₘₑₐₛ can be performed, for example, in the following way:

First, the auxiliary temperature Tₐᵤₓ delivered by the auxiliary temperature sensor 307 is converted with the assistance of the transfer characteristic line for the second thermocouple 405 into an associated auxiliary voltage Uₐᵤₓ. To this reference voltage Uₐᵤₓ is then added the measurement voltage U_{tc2} delivered by the second thermocouple 405. The so obtained summed voltage Uₐᵤ+U_{tc2} is translated by means of the transfer characteristic line for the second thermocouple 405 into a temperature, and, as a result, one obtains the reference temperature T_{ref}. With the help of the measurement voltage U_{tc2} delivered by the second thermocouple 405, one can, thus, starting from the auxiliary temperature Tₐᵤₓ, very exactly determine the reference temperature T_{ref}.

With this reference temperature T_{ref}, one then uses the transfer characteristic line for the first thermocouple 100 to translate the reference temperature T_{ref} into an associated reference voltage U_{ref}. To this reference voltage U_{ref} is then added the measurement voltage U_{tc} delivered by the first thermocouple 100, and as result one obtains the summed voltage U_{ref}+U_{tc}. Using the transfer characteristic line, one converts this summed voltage U_{ref}+U_{tc} into an associated temperature and so obtains the measurement temperature Tₘₑₐₛ. In this way, the measurement temperature Tₘₑₐₛ can be determined based on the reference temperature T_{ref} determined with high accuracy.

1-18. (canceled)

19. A measuring apparatus for determining a measurement temperature at a measuring point by means of a first thermocouple, wherein the measuring apparatus comprises:
an evaluating electronics, which is designed to determine the measurement temperature at said measuring point;
a first connection terminal and a second connection terminal for connecting said first thermocouple;
a first connecting line and a second connecting line, which connect said first connection terminal and the second connection terminal with said evaluating electronics; and
an auxiliary temperature sensor, which is arranged removed from the connection terminals and is designed to register an auxiliary temperature at the site of the auxiliary temperature sensor, wherein:
there is connected at said second connection terminal with said second connecting line an additional connecting line, which is composed of a material other than that of said second connecting line;
said additional connecting line forms together with said second connecting line a second thermocouple, which is likewise connected to said evaluating electronics;
said second thermocouple delivers a second measurement voltage, which depends on the second temperature difference between the temperature of said second connection terminal and the auxiliary temperature at the site of said auxiliary temperature sensor; and
said evaluating electronics is designed, based on a first measurement voltage delivered by said first thermocouple, the second measurement voltage delivered by said second thermocouple and the auxiliary temperature registered by said auxiliary temperature sensor, to determine the measurement temperature at said measuring point.

20. The measuring apparatus as claimed in claim 19, wherein:
said second thermocouple is provided to register a second temperature difference between the temperature of said second connection terminal and the auxiliary temperature at the site of said auxiliary temperature sensor.

21. The measuring apparatus as claimed in claim 19, wherein:
the apparatus includes at least one feature as follows:
said first connection terminal is electrically connected with said evaluating electronics via a first connection pin;
said second connection terminal is electrically connected with said evaluating electronics via a second connection pin;
said additional connecting line is led out of said second connection terminal by means of a third connection pin and is electrically connected with said evaluating electronics via the third connection pin, wherein said additional connecting line and said third connection pin are of the same material;
said second connection terminal is connected with said evaluating electronics via said second connection pin and the third connection pin;
said second connection terminal is connected with said evaluating electronics via said second connection pin and said third connection pin, wherein the second measurement voltage delivered by said second thermocouple lies across said second connection pin and said third connection pin.

22. The measuring apparatus as claimed in claim 19, wherein:
the apparatus includes at least one feature as follows:
the measuring apparatus is embodied as a head transmitter having an upper side, wherein the connection terminals are arranged on said upper side of the head transmitter;
the measuring apparatus is accommodated in a round field housing, wherein the connection terminals are arranged in a connector space of said field housing; or
the measuring apparatus is accommodated in a DIN rail housing, wherein the connection terminals are implemented by means of a pin connector socket.

23. The measuring apparatus as claimed in claim 19, the apparatus includes at least one feature as follows:
said auxiliary temperature sensor is placed within a housing of the measuring apparatus;
said auxiliary temperature sensor is embodied as part of said evaluating electronics;
said auxiliary temperature sensor is arranged on a circuit board of said evaluating electronics;
said auxiliary temperature sensor is arranged in spatial vicinity of the connection terminals;
said evaluating electronics is designed, based on a measured variable delivered by said auxiliary temperature sensor, to determine an auxiliary temperature at the site of said auxiliary temperature sensor;
the auxiliary temperature sensor is a resistance sensor.

24. The measuring apparatus as claimed in claim 19, wherein:
said measuring apparatus is a temperature transmitter, wherein selectively different thermocouples are connectable at the connection terminals as a function of measuring situation.

25. A temperature measuring device for determining a measurement temperature at a measuring point, comprising:
a measuring apparatus as claimed in claim 19; and
a first thermocouple, which is connected to the first connection terminal and to said second connection terminal of said measuring apparatus.

26. The temperature measuring device as claimed in claim 25, the temperature measuring device includes at least one feature as follows:
said first thermocouple is provided to register a first temperature difference between the temperature at the measuring point and the temperature of the connection terminals;
said first thermocouple delivers a first measurement voltage, which depends on a first temperature difference between the temperature at the measuring point and the temperature of the connection terminals.

27. The temperature measuring device as claimed in claim 25, the temperature measuring device includes at least one feature as follows:
said second connection terminal serves as a reference junction for a first temperature difference registered by said first thermocouple;
the temperature of said second connection terminal serves as a reference temperature for a first temperature difference registered by said first thermocouple; or
said second thermocouple is provided to determine, based on the auxiliary temperature registered by the auxiliary temperature sensor, the temperature of said second connection terminal as a reference temperature for said first thermocouple.

28. The temperature measuring device as claimed in claim 19, wherein:
said evaluating electronics is designed to determine the temperature of said second connection terminal based on the auxiliary temperature registered by said auxiliary temperature sensor at the site of said auxiliary temperature sensor and the second measurement voltage delivered by said second thermocouple.

29. The temperature measuring device as claimed in claim 28, wherein:
said evaluating electronics is designed to determine the measurement temperature at the measuring point based on the temperature of said second connection terminal and the first measurement voltage delivered by said first thermocouple.

30. The temperature measuring device as claimed in claim 19, wherein:
said evaluating electronics is designed to convert the auxiliary temperature registered by said auxiliary temperature sensor at the site of the auxiliary temperature sensor by means of a transfer characteristic line for said second thermocouple into a corresponding auxiliary voltage;
to add to said so obtained auxiliary voltage the second measurement voltage delivered by said second thermocouple; and
to convert the voltage obtained as result of the addition by means of the transfer characteristic line for said second thermocouple into a corresponding temperature and so to determine the temperature of said second connection terminal.

31. The temperature measuring device as claimed in claim 30, wherein:
said evaluating electronics is designed to convert the temperature of said second connection terminal into a corresponding reference voltage by means of a transfer characteristic line for said first thermocouple,
to add to the so obtained reference voltage the first measurement voltage delivered by said first thermocouple; and
to convert the voltage obtained as result of the addition by means of the transfer characteristic line for said first thermocouple into a corresponding temperature and so to determine the measurement temperature at said measuring point.

32. The temperature measuring device as claimed in claim 25, wherein:
the temperature measuring devices includes at least one feature as follows:
said first thermocouple includes a first material pairing, and said second thermocouple includes a second material pairing, which is not necessarily the same as said first material pairing; or
the material of the second connecting line and the material of the additional connecting line are so selected that said second thermocouple can register temperature differences at operating temperature.

33. The temperature measuring device as claimed in claim 25, wherein:
the temperature measuring device includes at least one feature as follows:
the temperature measuring device is a field device;
the temperature measuring device includes a fieldbus interface for connection to a fieldbus system; or
the temperature measuring device is designed to exchange data with a fieldbus system according to one of the following fieldbus protocols: HART, Profibus, Fieldbus Foundation, an industrial Ethernet protocol.

34. A method for determining a measurement temperature at a measuring point by means of a temperature measuring device, wherein the temperature measuring device has:
a first connection terminal and a second connection terminal for connecting a first thermocouple; a first thermocouple connected to the first connection terminal and to the second connection terminal; a first connecting line and a second connecting line, which connect the first connection terminal and the second connection terminal with an evaluating electronics; an evaluating electronics, which is designed to determine the measurement temperature at the measuring point; an auxiliary temperature sensor, which is arranged removed from the connection terminals and is designed to register an auxiliary temperature at the site of the auxiliary temperature sensor; wherein there is connected in the second connection terminal with the second connecting line an additional connecting line, which is composed of a material other than that of the second connecting line, wherein the additional connecting line forms together with the second connecting line a second thermocouple, which is likewise connected to the evaluating electronics, wherein the method comprises the steps as follows:
evaluating a first measurement voltage across ends of the first thermocouple;
evaluating a second measurement voltage across ends of the second thermocouple;
ascertaining an auxiliary temperature at the site of the auxiliary temperature sensor by the auxiliary temperature sensor; and
determining the measurement temperature at the measuring point based on the auxiliary temperature at the site of the auxiliary temperature sensor, the first measurement voltage delivered by the first thermocouple and the second measurement voltage delivered by the second thermocouple.

35. The method as claimed in claim 34, further comprising the steps as follows:
transforming the auxiliary temperature registered by the auxiliary temperature sensor at the site of the auxiliary temperature sensor by means of a transfer characteristic line for the second thermocouple into a corresponding auxiliary voltage;
adding the second measurement voltage delivered by the second thermocouple to the so obtained auxiliary voltage; and
transforming the voltage obtained as result of the addition by means of the transfer characteristic line for the second thermocouple into a corresponding temperature, which corresponds to the temperature of the second connection terminal.

36. The method as claimed in claim 35, further comprising the steps as follows:
translating the temperature of the second connection terminal by means of a transfer characteristic line for the first thermocouple into a corresponding reference voltage;
adding the first measurement voltage delivered by the first thermocouple to the so obtained reference voltage; and
translating the voltage obtained as result of the addition by means of the transfer characteristic line for the first thermocouple into a corresponding temperature, which corresponds to the measurement temperature at the measuring point.
